(19) United States
(12) Patent Application Publication
(10) Pub. No.: US 2011/0172816 A1
(43) Pub. Date: Jul. 14, 2011

(54) FUEL DELIVERY PATHWAY CONTROL

(76) Inventor: Meir Ezra, Clearwater, FL (US)

(21) Appl. No.: 12/989,081

(22) PCT Filed: Apr. 27, 2009
(86) PCT No.: PCT/US09/41820

§ 371 Date: Oct. 22, 2010

Related U.S. Application Data
(60) Provisional application No. 61/047,763, filed on Apr. 25, 2008.

(51) Int. Cl. G06F 17/00

(52) U.S. Cl. 700/237

(57) ABSTRACT

A fuel delivery pathway control is provided for remotely monitoring and controlling the delivery of fuel from a producer to consumers Fueling vehicles transport the fuel from storage tanks at a fuel depot to fueling station storage tanks, and the fuel is then dispensed from the fueling station storage tanks to consumer vehicles Fuel delivery is controlled and authorized wirelessly

### CROSS-REFERENCE TO RELATED APPLICATIONS

This application is based on and claims the priority date of Applicant's copending U.S. Provisional Patent Application No. 61/047,763, filed Apr. 25, 2008, the disclosure of which is incorporated herein by referenced.

### STATEMENT REGARDING FEDERALLY SPONSORED RESEARCH OR DEVELOPMENT

Not Applicable.

### PARTIES TO A JOINT RESEARCH AGREEMENT

Not Applicable.

### FIELD OF THE INVENTION

The present invention is in the field of fuel delivery from the producer to the consumer. More specifically the present invention relates to a system and method to secure the entire chain of fuel delivery from the producer to the consumer against theft, errors in fueling and retail fuel purchases from unauthorized fuel wholesalers.

### BACKGROUND OF THE INVENTION

Common complaints expressed by fuel distribution companies are loss of revenues due to fuel theft, errors in fueling and retail fuel purchases from unauthorized fuel wholesalers. Thus, there is a need in the art for a completely secure fueling process from depot/terminal to station delivery, eliminating the possibility of fuel inappropriately fuel disappearing during the fuel delivery process.

### BRIEF DESCRIPTION OF THE SEVERAL VIEWS OF THE DRAWING

The present invention will be understood and appreciated more fully from the following detailed description, taken in conjunction with the drawing in which

FIG. 1 is a schematic description of the framework within which the present invention is implemented.

### DETAILED DESCRIPTION OF THE INVENTION

In accordance with some embodiments of the present invention, a communications network communicates wirelessly to control the opening, closing and locking of secure delivery/intake valves permitting only authorized fueling transactions. Secure valves are installed in several places, typically on the fueling truck inlets and outlets, and underground fuel tank inlets. These valves are opened only by electronic permission occurring when a set of predefined circumstances are present, thus ensuring fuel is accounted for and delivered correctly. These actions are monitored on a computer system installed in each truck in conjunction with a GPS locating system, typically also with a fuel gauging system, a wireless identification protocol, functioning together as the pipe connect system. The computer system is able to issue reports on all fueling activities, including time, location and quantities.

The process for securing the entire chain of fuel delivery from the producer to the consumer against fuel theft, errors in fueling and retail fuel purchases from unauthorized fuel wholesalers consists of three stages:

1) loading fueling trucks at the fuel depot/terminal;

2) transporting the fuel;

3) delivering the fuel to the fueling stations.

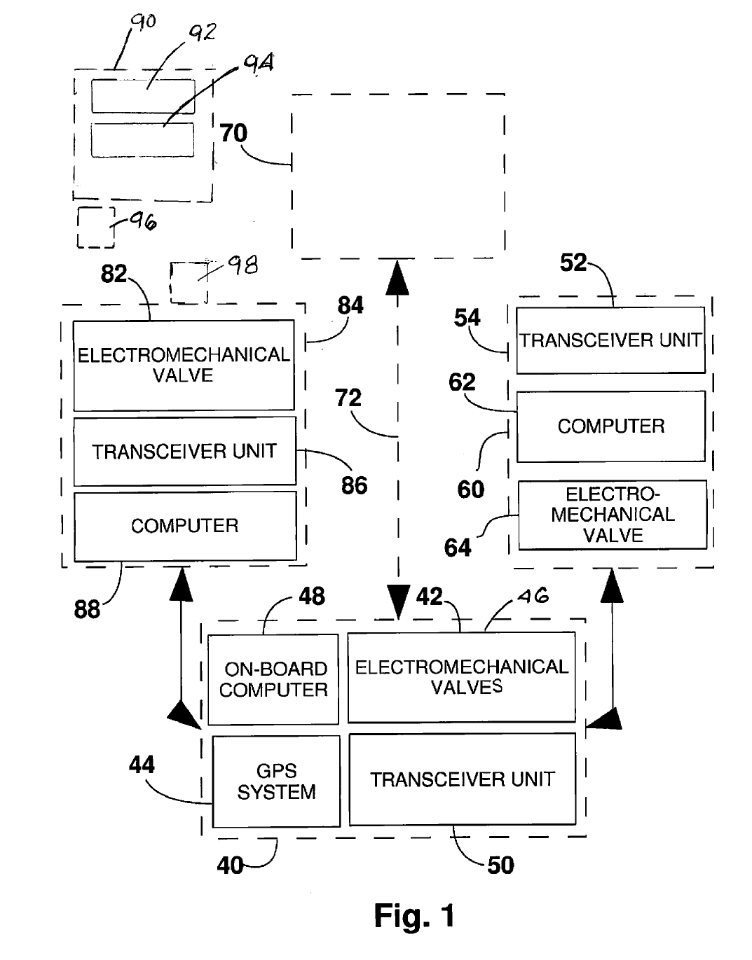

A detailed description of each stage is described below in conjunction with FIG. 1.

### Loading Fueling Trucks at the Fuel Depot Terminal

In accordance with the present invention, a communications network is involved in the administration, control and monitoring of the delivery of the fuel from the fuel depot/terminal to the fuel delivery truck and ensures that only fuel that is authorized is dispensed from the fuel depot/terminal. In accordance with some embodiments of the present invention a delivery plan is dispatched to the fuel delivery truck's on-board computer. The fuel delivery truck (FDT) 40, further includes one or more electromechanical valves 42 which are disposed at the fueling inlet of FDT 40. The FDT further includes a geographic location GPS system 44. The inlet valves are opened at the fueling depot or terminal 60 only by an electronic permission received from the FDT onboard computer 48, where it is generated only upon fulfillment of the following conditions:

a) FDT's GPS system 44 sends a location information to FDT's onboard computer 48 that the FDT is located in the depot area.

b) Transceiver unit 50, also installed on FDT 40, communicates with transceiver 52 installed on the fueling pipe 54 of fuel terminal/depot 60. The communication between these two transceivers is to confirm that the electromechanical inlet valve 42 and fueling pipe 54 are in close proximity, preferably up to 5 centimeters. Such confirmation realized, transceiver 50 sends a message to computer 48 notifying accordingly.

c) Terminal 60 communicates wirelessly with FDT's onboard computer 48 and verifies proper connection (for example that the FDT is authorized to pipe fuel from the fuel depot) of the fuel pipe to the truck's inlet valve.

Only with these three conditions fulfilled will FDT's inlet valve 42 open. With the valve open, depot/terminal computer 62 can issue a fueling directive and permit fueling. The terminal may also issue, by way of its own computer 62, a permit to pipe valve 64 to open. After the FDT is loaded with fuel, valve 42 on board the truck is securely locked and cannot be reopened without a predefined electronic signature. All fuel delivered to the FDT and its destination is registered on the truck's onboard computer 48. A fuel level gauge monitors fuel level in the fueling truck. This information is transmitted to the system controller and is used to ensure that there is no unauthorized withdrawal of fuel from the tanks, as by making a hole in the fuel tank.

### Transporting the Fuel

As the FDT leaves depot/terminal 60, its activities can be monitored by central fueling site 70 which communicates wirelessly with FDT's GPS system 44. The wireless communication between the FDT 40 and central fueling control office (CFCO) 70 is designated by dashed double headed arrow 72. In accordance with some embodiments of the present invention, the CFCO 70 continuously monitors the quantity of fuel within the truck, also automatically accounting for volume increases and decreases due to density changes as measured, in addition to other physical changes that may occur. Because the electromechanical valves of the FDT are locked electronically, and the onboard computer 48 is notified of any change in volume and status of the fuel, no access to the load of fuel is permitted without a pre-established electronic signature, making the system substantially secure as regards fuel theft, errors in fueling and retail fuel purchases from unauthorized fuel wholesalers.

### Delivering the Fuel to the Fueling Stations

CFCO 70 controls and monitors the delivery of the fuel from FDT 40 to the underground tanks of fueling station 84 and ensures that only authorized fuel, in the correct quantities and grade, is dispensed from FDT 40 to the correct underground tank. A fuel level gauge in the tank confirms that fuel loaded on the FDT is actually delivered to the tank. All gauges are wireless, electronic gauges that transmit fuel level information to appropriate controllers. In addition to the electromechanical outlet valve 46 at the FDT, electromechanical inlet valve 82 is placed at the fuel inlet of the underground tank of fueling station 84. The outlet valve 46 of the FDT and inlet valve 82 of the underground tank are opened only by an electronic permit issued only upon fulfillment of the following:

a) The FDT's GPS system 44 advises the truck's on-board computer 48 that the truck is located in a correct, authorized fueling station according to the fuel delivery plan received from the authorized source, which can be changed remotely from depot/terminal 60 or CFCO 70. It should be noted that in some embodiments of the present invention, central station 70 can be located in depot/terminal 60.

b) Short range transceiver unit 50 installed on the FDT is disposed near electromechanical outlet valve 46 and communicates with another transceiver 86, which is installed near the station's underground tank inlet valve 82. The transceivers intercommunicate to confirm proximity.

c) FDT onboard computer 48 directs the FDT's outlet valves.

d) Fuel station computer 88 authorizes the underground inlet valve 82 to open.

e) Fuel station computer 88 communicates with the truck's onboard computer 48 and verifies proper connection of the FDT's fuel pipe to the station's inlet valve. Such a communication event may be effected via a medium range communication network or even via satellite communications network.

During the fueling process, the truck's onboard tank gauges the fuel and the underground tank gauge computers calculate the volume of fuel dispensed, accounting for volume adjustments necessitated by density changes.

Upon completion of the fueling process, the valves are again locked, preventing unauthorized access to the fuel. The fuel depot/terminal is immediately notified of the quantity and grade of fuel delivered.

### Fuel Consumption Monitoring and Administration by a Consumer Vehicle in the Refueling Station

As a vehicle 90 approaches the refueling station, a vehicle smart tag (VST) 92, which is installed thereon, preferably on the vehicle windshield, communicates with the communication unit installed in the refueling station 84 sending the information collected since the last refueling. The VST supplies the secure identification information about the vehicle, its engine hours, location data (GPS data), odometer reading, speed reading, driver behavior (harsh breaking and acceleration). Authorization to fuel is granted subject to the presence of a smart tag 94 that is installed around or next to the fueling inlet of the vehicle. In some cases authorization to fuel is granted subject to presentation by the driver of a handheld smart card 96 used to identify the driver in the fueling process. With the nozzle inserted into the fuel inlet, a reader 98 installed on the fueling nozzle becomes close enough to communicate with the communications tag element 94 near the vehicle fuel inlet. The data from the tag 94 next to the refueling inlet is sent via the communication unit installed on the refueling station to the office station 70, and if the data matches the data of the VST installed on the vehicle, authorization to fuel is granted. Removing the nozzle from the fuel inlet will break the communication between the nozzle reader which is installed on the fueling nozzle, and the tag on the vehicle tank near the fueling inlet, immediately stopping the flow of fuel. This measures the correct grade of fuel pumped to the correct vehicle by the correct driver.

Another feature of the invention is that the system can ensure that the fuel that is registered by the fuel pump as going out from the fuel pump to the vehicle is equal to the fuel actually getting out of the fuel tank at the station and equal to the fuel received by the vehicle. This is done by installing at the vehicle a unit that electronically connects to the fuel tank via the CAN BUS or OBDII or directly to a gauge on the vehicle fuel pump or to the car installed fuel gauge. The pump is monitored by an electronic measuring device that connects to the pump head or directly to the pump pulser. All of these features permit the system to check and verify fuel use and dispensing by multiple devices.

### OTHER FEATURES AND BENEFIT OF THE PRESENT INVENTION

Another feature of the present invention is that the various valves and controls can be protected from being manually overridden by placing the valves and other sensors in a protective enclosure or dome. The enclosure can be constructed to detect an attempt to mechanically access or manually manipulate the valves. A number of different types of devices can be used for this purpose. The valves can be placed in a vacuum or pressurized chamber, such that a pressure change caused by manual interference causes shutdown and lockdown of all valves that cannot be overridden. An electronic or light controlled interference detector or other such device could also be used. Any controls or measuring devices can be protected in this manner.

While the controls of this invention are designed to be administered by a computer in accordance with programmed instructions and data input from the various components of the system, the system also can be set up so that the approval of an individual operator is necessary for fuel transfer operation.

The system implemented in accordance with the present invention addresses the significant problems experienced by the major participants in the fueling industry. Depot/terminal operators want to increase their control over the fuel delivery process, eliminate fuel theft and fuel degradation, and ensure the correct amount and grade of fuel is properly delivered to the correct service station safely. Oil companies want to maintain and increase customer loyalty and profits. Home base operators need to control mobile fueling and in-house fueling facilities and fleet owners want to eliminate fraud committed by drivers and depot operators and gain real time control over their fleet vehicle.

While all of the features of the present invention can be advantageously be used together to provide a comprehensive monitoring and control system, it is not required that all elements be used together. Benefits are obtained by the use of each feature individually.

What is claimed is:

1. A fuel delivery pathway control for remotely monitoring and controlling the delivery of fuel from a producer to consumers, wherein fueling vehicles transport the fuel from storage tanks at a fuel depot to fueling station storage tanks, and the fuel is then dispensed from the fueling station storage tanks to consumer vehicles, the process including the steps of:
providing the fuel depot storage tanks with wireless, electronically controlled shut-off valves that prevent fuel from being added to or removed form the storage tanks without approval;
providing the fueling vehicles with wireless, electronically controlled shut-off valves that prevent fuel from being received into or discharged from the fueling vehicles without authorization;
providing the fueling station storage tanks with one or more wireless electronically controlled shut-off valves that prevent the receipt or discharge of fuel therefrom without authorization; and
providing a wireless electronic system controller that receives information from the fuel depot, fueling vehicles, fueling stations, and commercial vehicles and generates wireless electronic instructions that authorize or withhold authorization for fuel transfer depending on the nature of the data received by the system controller in relation to authorization criteria in the controller.

2. A process as in claim 1 wherein the fueling vehicle is provided with an electronic position determining mechanism that determines the geographic location of the vehicle, and such position information is transmitted to and received by the controller, the controller factoring in the fueling vehicle's position in determining whether to authorize receipt or discharge of fuel from the vehicle at a particular location.

3. A process as in claim 1 wherein the fueling vehicle is provided with a transceiver adjacent a fuel inlet and the fuel depot is provided with a transceiver adjacent an outlet of a fueling pipe, with the transceiver being in communication such that fueling authorization is permitted only when the transceivers are in sufficiently close proximity to each other to indicate that the fueling pipe outlet is connected to the fueling vehicle storage tank inlet, authorization being discontinued when such proximity is discontinued, whereby dispensing fuel to an unauthorized tank is inhibited.

4. A process as in claim 1 wherein the fueling vehicle is provided with a wireless electronic vehicle controller and electronic fuel gauges that detect the fuel level in the vehicle storage tank as well as other conditions that affect fuel volume, the vehicle controller also detecting the grade of fuel received in the vehicle storage tank when the fuel is to be received at the fuel depot, such information being used by the system controller to determine authorization to receive or discharge fuel.

5. A process as in claim 1 wherein the consumer vehicle includes a first electronic vehicle smart tag adjacent a fuel inlet that communicates with a computer at the fueling station and provides information about the vehicle and one or more of engine hours, GPS location data, odometer reading, speed reading, driver behavior data represented by onboard braking or acceleration detectors, the vehicle also including a second smart tag in proximity to the fuel tank inlet that detects when the fuel nozzle is in the fuel tank and thereafter authorizes fuel pump activation.

6. A process as in claim 5 and further comprising a portable smart tag that is carried by the vehicle driver and must be detected by the fueling controller in addition to the vehicle mounted smart tag in order to authorize fuel dispensation to the vehicle.
